(19) United States
(12) Patent Application Publication
(10) Pub. No.: US 2012/0283364 A1
(43) Pub. Date: Nov. 8, 2012

(54) POLYMER BLENDS COMPRISING PHASE-ENCAPSULATED THERMOPLASTIC STARCH AND PROCESS FOR MAKING THE SAME

(75) Inventors: PIERRE SARAZIN, MONTREAL (CA); BASIL D. FAVIS, KIRKLAND (CA)

(73) Assignee: CERESTECH, INC., MONTREAL (CA)

(21) Appl. No.: 13/464,209

(22) Filed: May 4, 2012

Related U.S. Application Data
(60) Provisional application No. 61/483,363, filed on May 6, 2011.

(51) Int. Cl. C08L 3/02

(52) U.S. Cl. 524/47

(57) ABSTRACT

New polymer blends are provided. These blends comprise a first polymer, a second polymer and thermoplastic starch, the thermoplastic starch being at least partially encapsulated in the second polymer. The polymer blends may be shaped into articles, for example by extrusion or injection molding.

### CROSS REFERENCE TO RELATED APPLICATIONS

This application claims benefit, under 35 U.S.C. §119(e), of U.S. provisional application Ser. No. 61/483,363, filed on May 6, 2011. All documents above are incorporated herein in their entirety by reference.

### FIELD OF THE INVENTION

The present invention relates to polymer blends. More specifically, the present invention is concerned with polymer blends comprising phase-encapsulated thermoplastic starch.

### BACKGROUND OF THE INVENTION

Environmental issues concerning the use of petroleum-based polymers have generated significant interest in the development of polymers from renewable resources.

Starch, the main plant reserve of polysaccharide, is highly renewable and biodegradable. Starch contains two macromolecules, amylose, which is essentially linear, and amylopectin, which is highly branched. With an excess of water, which acts as a plasticizer, and heat, starch granules can lose their crystalline structure and swell in a phenomenon called gelatinization that produces thermoplastic starch (TPS). Other plasticizers, such as glycerol and sorbitol, can also be added to starch to produce TPS. The transformation of granular starch into a thermoplastic-like material allows it to be processed in a fashion similar to conventional plastics. However, TPS typically exhibits poor mechanical properties and shows high moisture sensitivity.

On another subject, polylactic acid (PLA) is a biobased polymer that can replace polymers derived from petroleum sources in injection molded articles. The addition of TPS to PLA was attempted in the past and it was found that, in comparison to pure PLA and pure TPS, the blends showed a decrease in elongation at break, tensile strength and impact resistance. In a study on HDPE/TPS blends, it has been shown that a significant increase in mechanical properties for high density polyethylene (HDPE)/TPS blends could be achieved by adding an HDPE grafted maleic anhydride interfacial modifier into HDPE/TPS blend. It has also been shown that an increase in mechanical properties for PLA/TPS blends could be achieved in the blends comprising maleic anhydride-grafted PLA.

### SUMMARY OF THE INVENTION

In accordance with the present invention, there is provided:
1. A polymer blend comprising a first polymer and a second polymer, and further comprising thermoplastic starch being at least partially encapsulated in said second polymer.
2. The polymer blend of item 1, wherein the thermoplastic starch is totally encapsulated in said second polymer.
3. The polymer blend of item 1 or 2, wherein said second polymer is a polyester such as poly(butylene adipate co-terephtalate) (PBAT), polybutylene succinate (PBS), polybutylene succinate-co-adipate (PBSA), or polycaprolactone (PCL), polyvinyl alcohol (PVOH), ethylene vinyl alcohol (EVOH), polyamide (PA), polyether block amide (PEBA), polystyrene, a polyolefin, ethylene vinyl acetate (EVA), or mixtures thereof.
4. The polymer blend of item 3, wherein said second polymer is poly(butylene adipate co-terephtalate) (PBAT), polyvinyl alcohol (PVOH), polybutylene succinate-co-adipate (PBSA), or polycaprolactone (PCL).
5. The polymer blend of any one of items 1-4, wherein said first polymer is a poly(hydroxyalkanoate) (PHA), a copolymer of poly(hydroxyalkanoates), poly(3-hydroxybutyrate-hydroxyvalerate) (PHBV), a polyester such as an aliphatic polyester, a thermoplastic homopolymer resin, a vinyl polymer, a polystyrene, a substantially water-insoluble polyacrylate or polymethacrylate, a polyacetal, a polyamide, a polyarylether, a polyurethane, a polycarbonate, a polyimide, a high molar mass substantially water-insoluble or crystallizable poly(alkylene oxide), a water-insoluble thermoplastic alpha-olefin copolymer, an acrylic acid ester/acrylonitrile copolymer, acrylamide/acrylonitrile copolymer, a block copolymer of amide-ester, a block copolymer of urethane-ether, block copolymers of urethane-ester, a polyolefin, alkylene/vinyl ester-copolymers or mixtures thereof.
6. The polymer blend of any one of items 1-5, wherein said first polymer is poly(lactic acid) (PLA), poly(glycolic acid), polybutylene succinate, copolymers comprising the repetitive units of poly(glycolic acid) and polybutylene succinate, polyethylene (PE), polypropylene (PP), polyisobutylene, poly (vinyl chloride) (PVC), poly (vinyl acetate) (PVA), poly (acrylic acid) esters, poly (methacrylic acid) esters, nylon6, nylon-6,6, an aliphatic or aromatic polyamide, poly(ethylene terephthalate) (PET), poly(butylene terephthalate) (PBT), poly(ethylene oxide), poly(propylene oxide), ethylene/vinyl acetate-copolymers (EVA), ethylene/vinyl alcohol-copolymers (EVAL); alkylene/acrylate or methacrylate-copolymers, ethylene/acrylic acid-copolymers (EAA), ethylene/ethyl acrylate-copolymers (EEA), ethylene/methyl acrylate-copolymers (EMA); alkylene/maleic anhydride-copolymers, ethylene/maleic anhydride-copolymers, random, block, graft or core-shell styrenic copolymers, alpha-olefin/styrene-copolymers, hydrogenated and non-hydrogenated styrene/ethylene-butylene/styrene copolymers (SEBS), styrene/ethylene-butadiene copolymers (SEB); styrene acrylonitrile copolymers (SAN), acrylonitrile/butadiene/styrene copolymers (ABS), or mixtures thereof.
7. The polymer blend on any one of items 1-6, wherein the first and second polymers are:

| First polymer | Second polymer |
|---|---|
| PHA | PBAT |
| PLA | PBAT |
| PHBV | PVOH |
| PHBV | PBAT |
| PLA | PBSA |
| PLA | PCL. |

8. The polymer blend of any one of items 1-7, wherein said second polymer is PBAT.
9. The polymer blend of any one of items 1-7, wherein said second polymer is PBSA.
10. The polymer blend of any one of items 1-7, wherein said second polymer is PCL.
11. The polymer blend of any one of items 1-7, wherein said second polymer is PVOH.
12. The polymer blend of any one of items 1-11, wherein said first polymer is polylactic acid or a polyhydroxyalkanoate.
13. The polymer blend of item 12, wherein said first polymer is polylactic acid.
14. The polymer blend of item 12, wherein said first polymer is poly(3-hydroxybutyrate-hydroxyvalerate) (PHBV).
15. The polymer blend of any one of items 1 to 14, wherein said blend exhibits an elongation at break measured according to ASTM D-638 of at least 20%.
16. The polymer blend of item 15, wherein said elongation at break is of at least 50%.
17. The polymer blend of item 16, wherein said elongation at break is of at least 100%.
18. The polymer blend of item 17, wherein said elongation at break is of at least 200%.
19. The polymer blend of any one of items 1-18, wherein said blend exhibits an Izod notched impact resistance measured according to ASTM D-256 of at least 40 J/m.
20. The polymer blend of item 19, wherein said impact resistance is of at least 60 J/m.
21. The polymer blend of item 20, wherein said impact resistance is of at least 80 J/m.
22. The polymer blend of any one of items 1-21, wherein said blend comprises from about 1 wt % up to about 79 wt % of thermoplastic starch, based on the total weight of the blend.
23. The polymer blend of item 22, wherein said blend comprises about 20 wt % to about 60 wt % of thermoplastic starch, based on the total weight of the blend.
24. The polymer blend of any one of items 1-23, wherein said blend comprises up to about 50 wt % of said second polymer, based on the total weight of the blend.
25. The polymer blend of item 24, wherein said blend comprises up to about 30 wt % of said second polymer, based on the total weight of the blend.
26. The polymer blend of item 25, wherein said blend comprises up to about 25 wt % of said second polymer, based on the total weight of the blend.
27. The polymer blend of item 26, wherein said blend comprises up to about 20 wt % of said second polymer, based on the total weight of the blend.
28. The polymer blend of any one of items 1 to 27, wherein said blend comprises at least about 1 wt % of said second polymer, based on the total weight of the blend.
29. The polymer blend of item 28, wherein said blend comprises at least about 10 wt % of said second polymer, based on the total weight of the blend.
30. The polymer blend of item 29, wherein said blend comprises at least about 15 wt % of said second polymer, based on the total weight of the blend.
31. The polymer blend of any one of items 1-30, wherein said blend comprises from 20 wt % up to about 98 wt % of the first polymer, based on the total weight of the blend.
32. The polymer blend of any one of items 1-31, wherein said thermoplastic starch comprises a plasticizer which is glycerol, sorbitol, a polyol or a mixture thereof.
33. The polymer blend of item 32, wherein said plasticizer is glycerol.
34. The polymer blend of item 32 or 33, wherein said thermoplastic starch comprises from about 15 wt % up to about 40 wt % of said plasticizer based on the weight of thermoplastic starch.
35. The polymer blend of any one of items 1-34, wherein said blend is made by a process comprising the steps of:
   a) Providing a starch suspension comprising starch, water and plasticizer;
   b) Obtaining thermoplastic starch suspension by causing gelatinization and plasticization of the starch suspension by exerting heat and pressure on the starch suspension in a first extrusion unit;
   c) Venting off residual water from the TPS to obtain substantially moisture-free TPS;
   d) Obtaining a melt of the first and the second polymers in a second extrusion unit;
   e) Combining the melt obtained from step (d) with the substantially moisture-free TPS to obtain the final ternary blend; and
   f) Optionally, shaping the final blend from step (e) into an article.
36. The polymer blend of item 35, wherein in said step (f) the final blend is injection molded or extruded into said article.

### BRIEF DESCRIPTION OF THE DRAWINGS

In the appended drawings:

FIG. 1 shows Scanning Electron Microscopy (SEM) micrographs of (1a) TPS/PLA (50/50 wt %), (1b) TPS/PLA/PBAT (50/20/30 wt %) and (1c) TPS/PBAT (50/50 wt %). In each blend, the TPS contained 38 wt % of glycerol. TPS phase has been selectively extracted to improve the contrast between the phases.

FIG. 2 shows Atomic Force Microscopy (AFM) micrographs (Phase Mode) of (2a) TPS/PLA (50/50 wt %), (2b) TPS/PLA/PBAT (50/20/30 wt %) and (2c) TPS/PBAT (50/50 wt %). In each blend, the TPS contained 32 wt % of glycerol. The scale is 10 μm×10 μm.

FIG. 3 shows AFM micrographs (Phase Mode) of TPS/PLA/PBAT (35/50/15 wt %) on an injection molded bar. The TPS contained 32 wt % of glycerol. The scale is 10 μm×10 μm.

FIG. 4 shows SEM micrographs of (4a) TPS/PLA (50/50 wt %), (4b) TPS/PLA/PBAT (50/45/5 wt %), (4c) TPS/PLA/PBAT (50/40/10 wt %) and (4d) TPS/PLA/PBAT (50/30/20 wt %). For each blend, the TPS contained 38 wt % of glycerol. The TPS phase was extracted.

FIG. 5 shows (A) the Young modulus (MPa) measured without extensometer, (B) the stress at break (MPa) and (C) the elongation at break (%) of PLA/PBAT blends and TPS/PLA/PBAT blends with 25 wt % TPS. In each blend, the TPS contained 38 wt % of glycerol. In the blend with 0 wt % PLA, the TPS/PBAT content was 25/75 wt %; in the blend with 50 wt % PLA, the TPS/PLA/PBAT content was 25/50/25 wt %; in the blend with 60 wt % PLA, the TPS/PLA/PBAT content was 25/60/15 wt %; and in the blend with 75 wt % PLA, the TPS/PLA content was 25/75 wt %.

FIG. 6 shows the Izod Notched impact (J/m) of PLA/PBAT blends and TPS/PLA/PBAT blends with 25 wt % TPS. In each blend, the TPS contained 38 wt % of glycerol. In the blend with 0 wt % PLA, the TPS/PBAT content was 25/75 wt %; in the blend with 50 wt % PLA, the TPS/PLA/PBAT content was 25/50/25 wt %; in the blend with 60 wt % PLA, the TPS/PLA/PBAT content was 25/60/15 wt %; and in the blend with 75 wt % PLA, the TPS/PLA content was 25/75 wt %.

FIGS. 7(A) to (D) show the mechanical properties (elongation at break, Izod notched impact, modulus, and stress at break, respectively) of TPS/PLA/PBAT blends with 25 w % TPS as a function of the wt % of PBAT. TPS32 and TPS 38 refer to a content of glycerol of 32 wt % and 38 wt % in the TPS, respectively. In FIG. 7 (C), the tensile modulus was measured without extensometer.

FIGS. 8 (A), (B), (C) and (D) show tensile and flexural properties for PLA/PBAT vs. PLA/TPS/PBAT blends with 25 wt % TPS. For each blend, the TPS contained 30 wt % of glycerol.

FIGS. 9 (A), (B), and (C) show the impact properties for PLA/PBAT vs. PLA/TPS/PBAT blends. HB and NB refer to hinge break and no break (as in FIG. 10). For each blend, the TPS contained 30 wt % of glycerol.

FIG. 10 shows the Izod Notched impact (J/m) of TPS/PLA/PBAT blends with 25 wt % TPS. In each blend, the TPS contained 38 wt % or 32 wt % of plasticizer (glycerol or sorbitol), referred to as TPS38 and TPS32 respectively. In the blend with 50 wt % PLA, the content of TPS/PLA/PBAT was 25/50/25 wt %; in the blend with 60 wt % PLA, the content of TPS/PLA/PBAT was 25/60/15 wt %; and in the blend with 75 wt % PLA, the content of TPS/PLA was 25/75 wt %.

FIG. 11 shows SEM micrographs of injection molded bars of (11a-1 and 2) TPS/PLA (25/75 wt %), (11b-1 and 2) TPS/PLA/PBAT (25/50/25 wt %) and (11c-1 and 2) TPS/PLA/PBAT (25/60/15 wt %) at various scales 1 mm (top row), 50 μm (11a-2) and 20 μm (11b-2 and 11c-2). For each blend, the TPS contained 38 wt % of glycerol. The TPS phase was extracted.

FIG. 12 shows the SEM micrographs of (12a-1 and 2) TPS/PHBV (50/50 wt %), (12b-1 and 2) TPS/PHBV/PVOH (50/40/10 wt %) and (12c-1 and 2) TPS/PHBV/PBAT (50/40/10 wt %). In each blend, the TPS contained 32 wt % of glycerol. For the pictures of the upper row, the scale represents 1 mm; for the pictures of the lower row, the scale represents 50 mm. The TPS phase was extracted. The PHBV was Tianan Y1000P.

FIGS. 13 (A), (B), and (C) show SEM micrographs for the blends PHBV/TPS28 (40/60); PHBV/PBAT/TPS28 (35/5/60) and PHBV/PBAT/TPS28 (30/10/60), respectively at two different scales: 1 mm (top row) and 50 μm (bottom row). The plasticizer used was glycerol at 28 wt %. The TPS phase was extracted.

FIG. 14 shows AFM micrograph (Phase Mode) of a TPS/PHBV/PBAT (60/10/30) blend at a 10×10 μm scale. The TPS contained 32 wt % of glycerol.

FIG. 15 shows AFM micrograph (Phase Mode) of another TPS/PHBV/PBAT blend (60/20/20) at a 10×10 μm scale. The TPS contained 32 wt % of glycerol.

FIG. 16 is a AFM micrograph (Phase Mode) of the blend of FIG. 14 after being diluted with PHBV, which resulted in a 30/55/15 TPS/PHBV/PBAT blend.

FIG. 17 shows variation of the Young modulus and the notched Izod impact as a function of the % PBAT in TPS/PHBV/PBAT blends containing 30% of TPS. The TPS contained 32 wt % of glycerol.

FIG. 18 shows an AFM micrograph of a TPS38/PLA3001D/PBSA (50/20/30) blend. The plasticizer used was glycerol at 38 wt %.

FIG. 19 shows an AFM micrograph of a TPS38/PLA3001D/PCL (50/20/30) blend. The plasticizer used was glycerol at 38 wt %.

FIG. 20 shows the modulus and the notched Izod impact of TPS/PHA/PBAT blends. The blends comprised 30 wt % of TPS and the PHA was Ecomann EM20010. The TPS contained 32 wt % of glycerol. PB indicates the partial break of the sample.

### DETAILED DESCRIPTION OF THE INVENTION

Turning now to the invention in more details, there is provided, according to an aspect of the present invention, a novel polymer blend comprising a first polymer and a second polymer. This blend further comprises thermoplastic starch (TPS) that is at least partially encapsulated in the second polymer.

Herein, a “polymer blend” is a material made of two or more polymers blended together to create a new material with physical properties different from that of the original polymers. In this polymer blend, the first and second polymers form two phases. Either of these phases may be continuous (being in a sense a matrix for the other components of the blend). In some cases, both these phases may be co-continuous.

In the polymer blend of the invention, the TPS forms a third phase, which is at least partly encapsulated by the second polymer. The TPS phase is said to be totally encapsulated when the second polymer cover its entire surface. In such cases, the TPS phase does not make contact with the first polymer phase. On the other hand, the TPS phase may be only partly encapsulated in the second polymer. In such cases, the second polymer does not entirely cover the surface of the TPS phase surface and the TPS phase makes contact with the first polymer phase.

The blends according to some embodiments of the present invention provide the advantage of a high bio-based content. They may also be biodegradable and/or compostable.

Non-exhaustive examples of first polymers include:
poly(hydroxyalkanoates) (PHA), such as poly(3-hydroxybutyrate-hydroxyvalerate) (PHBV), and copolymers of poly(hydroxyalkanoates);
polyesters, such as aliphatic polyesters like poly(lactic acid) (PLA), poly(glycolic acid), and polybutylene succinate and copolymers comprising the repetitive units of both, such polyesters include polyesters that are partially or totally bio-sourced, which are also called biopolyesters;
as well as mixtures thereof.

Further examples of the first polymer include thermoplastic homopolymer resins such as:
polyolefins, for example polyethylene (PE), polypropylene (PP), polyisobutylene;
vinyl polymers, such as poly (vinyl chloride) (PVC), poly (vinyl acetate) (PVA);
polystyrenes;
substantially water-insoluble polyacrylates or polymethacrylates, such as poly (acrylic acid) esters, poly (methacrylic acid) esters;
polyacetals (POM);
polyamides, such as nylon6, nylon-6,6, aliphatic and aromatic polyamides;
polyesters, such as poly(ethylene terephthalate) (PET), poly(butylene terephthalate) (PBT), including biopolyesters;
polyarylethers;
polyurethanes;
polycarbonates;
polyimides; and
high molar mass, substantially water-insoluble or crystallizable poly(alkylene oxides), such as poly(ethylene oxide), poly(propylene oxide), and mixtures thereof.

Further examples of the first polymer include substantially water-insoluble thermoplastic alpha-olefin copolymers. Examples of which are copolymers of alkylene/vinyl ester-copolymers such as ethylene/vinyl acetate-copolymers (EVA), ethylene/vinyl alcohol-copolymers (EVOH); alkylene/acrylate or methacrylate-copolymers preferably ethylene/acrylic acid-copolymers (EAA), ethylene/ethyl acrylate-copolymers (EEA), ethylene/methyl acrylate-copolymers (EMA); alkylene/maleic anhydride-copolymers preferably ethylene/maleic anhydride-copolymers; and mixtures thereof.

Further examples of the first polymer are styrenic copolymers, which comprise random, block, graft or core-shell architectures. Examples of such include styrenic copolymers such as alpha-olefin/styrene-copolymers preferably hydrogenated and non-hydrogenated styrene/ethylene-butylene/styrene copolymers (SEBS), styrene/ethylene-butadiene copolymers (SEB); styrene acrylonitrile copolymers (SAN), acrylonitrile/butadiene/styrene copolymers (ABS); and mixtures thereof.

Further first polymers include other copolymers such as acrylic acid ester/acrylonitrile copolymers, acrylamide/acrylonitrile copolymers, block copolymers of amide-esters, block copolymers of urethane-ethers, block copolymers of urethane-esters; as well as mixtures thereof.

In specific embodiments, the first polymer is polylactic acid (PLA), a polyhydroxyalkanoate (PHA), such as PHBV (poly-3-hydroxy butyrate-co-valerate), or a mixture thereof.

In embodiments, the first polymer is polylactic acid (PLA).

Turning now to the second polymer, it encapsulates the TPS and preferably has a good affinity with the first polymer. Non-exhaustive examples of the second polymer include polyesters (including biopolyesters) such as poly(butylene adipate co-terephtalate) (PBAT), polybutylene succinate (PBS), polybutylene succinate-co-adipate (PBSA), and polycaprolactone (PCL), polyvinyl alcohol (PVOH), ethylene vinyl alcohol (EVOH), polyamide (PA), polyether block amide (PEBA), polystyrene, polyolefins, vinyl acetate ethylene or mixtures thereof.

In specific embodiments, the second polymer is poly(butylene adipate co-terephtalate) (PBAT), polyvinyl alcohol (PVOH), polybutylene succinate-co-adipate (PBSA), or polycaprolactone (PCL).

In embodiments, the second polymer is poly(butylene adipate co-terephtalate) (PBAT).

In embodiments, the first and second polymers are as follow:

| First polymer | Second polymer |
|---|---|
| PHA | PBAT |
| PLA | PBAT |
| PHBV | PVOH |
| PHBV | PBAT |
| PLA | PBSA |
| PLA | PCL |

As used in the present application, and as is well known in the art, compatibilization is herein distinguished from encapsulation. The compatibilization of polymer blends generally involves interfacial modification using premade or in-situ generated copolymers. These modifiers go to the interface and part of the copolymer has an affinity for and interpenetrates one phase of the polymer blend while the other part of the copolymer has an affinity for and interpenetrates the other phase of the polymer blend. In the present application, TPS is encapsulated by the second polymer which is different from the addition of an interfacial modifier. Encapsulation is determined by observing TPS domains located within the second polymer phase, as determined by microscopic techniques such as, but not limited to, atomic force microscopy (AFM).

Further, encapsulation of the TPS by the second polymer may be partial, although full encapsulation is generally preferred. It was observed however that, compared with blends of TPS with the first polymer only, partial encapsulation can result in better properties due to the combined effects of the decrease of the size of TPS phase domains with property changes brought by the second polymer itself.

In a specific embodiment, the polymer blend of the invention comprises PLA as the first polymer and PBAT as the second polymer. Pure PLA exhibits a high Young modulus but very low elongation at break. Further, it shows limited compostability when very thick. The addition of TPS to PLA was found to allow a faster biodegradation. It also decreases the price of the final product. However, the mechanical properties of this binary blend still remained poor. Other “second” polymers were thus added to the PLA. One such second polymer was PBAT (polybutylene adipate-co-terephthalate), which exhibits a low Young modulus and a high elongation at break. It was found as shown in the Examples below that the PLA/PBAT/TPS ternary blend (i.e. a blend of the invention) exhibited an unexpected encapsulated morphology where dispersed TPS domains were trapped within the PBAT phase and absent from the PLA phase. This controlled morphology also unexpectedly provided good mechanical properties (compared to the un-encapsulated PLA/TPS blend) as can be seen in the examples below.

The encapsulated morphology of the blends of the invention leads to desirable mechanical properties such as high elongation at break (measured according to ASTM D-638). Other mechanical properties that were investigated included Izod impact notched and unnotched tests, measured according to ASTM D-256 and ASTM D-4812, the Gardner impact, measured according to ASTM D5420, and flexural properties measured according to ASTM D-790.

For example, as shown in the examples below, ternary blends containing PLA as the first polymer had better mechanical properties, including elongation at break and impact resistance, than PLA. More particularly, the elongation at break of the ternary PLA blends, measured according to ASTM D-638, at least matched that of pure PLA and was preferably higher than 100%, 200%, 400%, 600%, 800% or 1000% the elongation at break of pure PLA. More preferably, the elongation at break, measured according to ASTM D-638 for injection molded bars of the ternary blends containing PLA as the first polymer is at least 20%; 50%; 100%; 150%, or 200% (with an elongation at break around 3-10% for pure PLA). In the specific embodiments in which the first polymer is PLA, the ternary blend preferably exhibits Izod notched impact resistances at least 30%, 50%, 100%, 150% or 200% higher than the notched impact resistance of pure PLA. More preferably, the Izod notched impact properties of the ternary blend containing PLA as the first polymer is at least 40, 50, 60, 70 or 80 J/m (with an Izod impact for pure PLA usually being between 20-33 J/m). The PLA ternary blend preferably exhibits an unnotched impact resistance at least 30%, 50%, 100%, 150% or 200% higher than the notched impact resistance of pure polylactide. More preferably, the Izod unnotched impact resistance of the ternary blend containing PLA as the first polymer is at least 300, 350, 400, 450 or 500 J/m or is characterized by the non-break of the sample by a pendulum of 30 lbs. The PLA ternary blend preferably exhibits a Gardner impact resistance of up to 100%, 250%, 400%, 600%, 800%, 1000%, 1250%, 1500%, 1750%, or 2000% higher than the Gardner impact resistance of pure polylactide. More preferably, the Gardner impact resistance of the ternary blend containing PLA as the first polymer is of at least 8, 15, 30, 40, 75, 100, 150, 200, 250 or 300 lbs.

The polymer blends of the invention may contain from about 1 wt % up to about 79 wt % of thermoplastic starch, for example from about 5 wt % to about 60 wt % of TPS based on the total weight of the blend, preferably about 20 to about 40 wt % of TPS. Any type of starch may be used, such as for example potato, corn, tapioca etc. The polymer blends may contain from about 20 wt % up to about 98 wt % of the first polymer. The polymer blends of the invention contain the second polymer in an amount sufficient to encapsulate or partially encapsulate the TPS. Higher amounts of the second polymer can be added to maximize the encapsulation of the TPS, depending on the targeted properties of the final polymer blend. For example, the blend may comprise at least about 1, 10, or 15 wt % and/or up to about 20, 25, 30 or 50 wt % of said second polymer, based on the total weight of the blend.

The process for making the above polymer blends stems from the process for making TPS and polymer compositions containing TPS described in U.S. Pat. Nos. 6,844,380 and 6,605,657 as well as US patent application publication No. 2008/0287592 A1, all of which are incorporated herein by reference. The process comprises the steps of:
(a) providing a starch suspension comprising starch, water and a plasticizer;
(b) obtaining a thermoplastic starch from the starch suspension by causing gelatinization and plasticization of the starch suspension by exerting heat and pressure on the starch suspension in a first extrusion unit;
(c) venting off residual water from the TPS to obtain a substantially moisture-free TPS;
(d) obtaining a melt of the second and the first polymers in a second extrusion unit;
(e) combining the melt obtained from step (d) with the substantially moisture-free TPS to obtain the final ternary blend; and
(f) optionally, shaping the final blend into an article.

In step (f) of the above process, the final blend may be shaped into an article via for example injection molding or extrusion.

Any suitable plasticizer or mixture of plasticizers may be used to produce the thermoplastic starch. For example, the plasticizers disclosed in U.S. Pat. No. 6,605,657 and U.S. Pat. No. 6,844,380, which are herein incorporated by reference, can be used. Examples of plasticizers include glycerol, polyglycerol, sorbitol, mannitol, erythritol, xylitol, maltitol, low molecular weight polyethylene glycols (PEGs), low molecular weight poly (vinyl alcohol), isosorbide, sorbitans, urea, sugar polyols (e.g. arabitol, iditol . . . ) as well as mixtures thereof. Other examples include oxyethylated polyalcohols, low molecular weight polypropylene glycols (PPGs), oxypropylated polyalcohols, epoxidized linseed oil, glycerol trioleate, tributyl citrate, pentaerythritol, 2,2,4-trimethyl-1,3-pentanediol isobutyrate, trimethylolpropane, diethylene glycol, ethylene glycol, sodium lactate, acetyl triethyl citrate, glyceryl triacetate, methyl esters of citric, lactic, succinic, adipic, glutaric or acetic acids, ethyl esters of citric, lactic, succinic, adipic, glutaric or acetic acids, fatty esters of citric, lactic, succinic, adipic, glutaric or acetic acids, esters of polyols (glycerol, mannitol, sorbitol, etc. . . . ). In embodiments, the plasticizer is glycerol, sorbitol, a polyol or a mixture thereof.

Generally, with less plasticizer, the TPS becomes more rigid and exhibits less elongation at break and less resistance to impact. The type and amount of plasticizer may thus be varied depending on the targeted properties of the final blend. Preferably, the plasticizers are glycerol and/or sorbitol. The plasticizer may be added in an amount of 15 to 40 wt % based on the weight of the thermoplastic starch. Without being bound by theory, it is believed that adding the plasticizer to the thermoplastic starch ensures that the starch is destructurized and that the plasticizer is well dispersed throughout the starch material. It is believed that this leads to the above mechanical properties of the TPS.

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or 5% of the numerical value qualified.

Unless otherwise defined, all technical and scientific terms used herein have the same meaning as commonly understood by one of ordinary skill in the art to which this invention belongs.

Other objects, advantages and features of the present invention will become more apparent upon reading of the following non-restrictive description of specific embodiments thereof, given by way of example only with reference to the accompanying drawings.

### DESCRIPTION OF ILLUSTRATIVE EMBODIMENTS

The present invention is illustrated in further details by the following non-limiting examples.

### Example 1

### One Step Extrusion Process

A ternary blend of TPS/PLA/PBAT was obtained in a one-step extrusion process. Corn starch was obtained from Cargill LLC. The PLA (NatureWorks® Ingeo™ 3001D Injection Grade PLA) was supplied by NatureWorks LLC and the PBAT was obtained from BASF (under Ecoflex®). The glycerol was supplied by LabMat and was pure at 99.5% (0.5% of water).

The processing of the TPS/PLA/PBAT blends was achieved using an extrusion system composed of a single-screw extruder (SSE) connected midway to a co-rotating twin-screw extruder (TSE). The starch/glycerol/water suspension was fed in the first zone of the TSE. Native starch was gelatinized and plasticized and volatiles were extracted in the first part of the TSE. Molten PLA and PBAT were fed from the SSE to about midway on the TSE. TPS, PLA and PBAT were then mixed in the latter part of the TSE. The TSE screw speed was 200 rpm for all blends. A strand die (diameter 3 mm) was used and strands were water cooled, followed by air cooling and then pelletized.

The final TPS/PLA/PBAT blend compositions contained 50% wt TPS. Different dilutions were made to obtain blends containing less TPS.

Evolution of the Morphology

The morphology of the blends was studied using a scanning electron microscope (SEM). Samples from extruded strands were cryogenically fractured perpendicular to the machine direction and microtomed at −150° C. under liquid nitrogen using a glass knife to create a plane surface. The instrument was a Leica-Jung RM 2165 equipped with a Leica LN 21 type cryochamber. TPS was extracted at room temperature with 6N HCl for 3 hours. The samples were then washed with water, dried under air and coated with a gold-palladium alloy. The observations were carried out using a Jeol JSM 840 Scanning Electron Microscope (SEM).

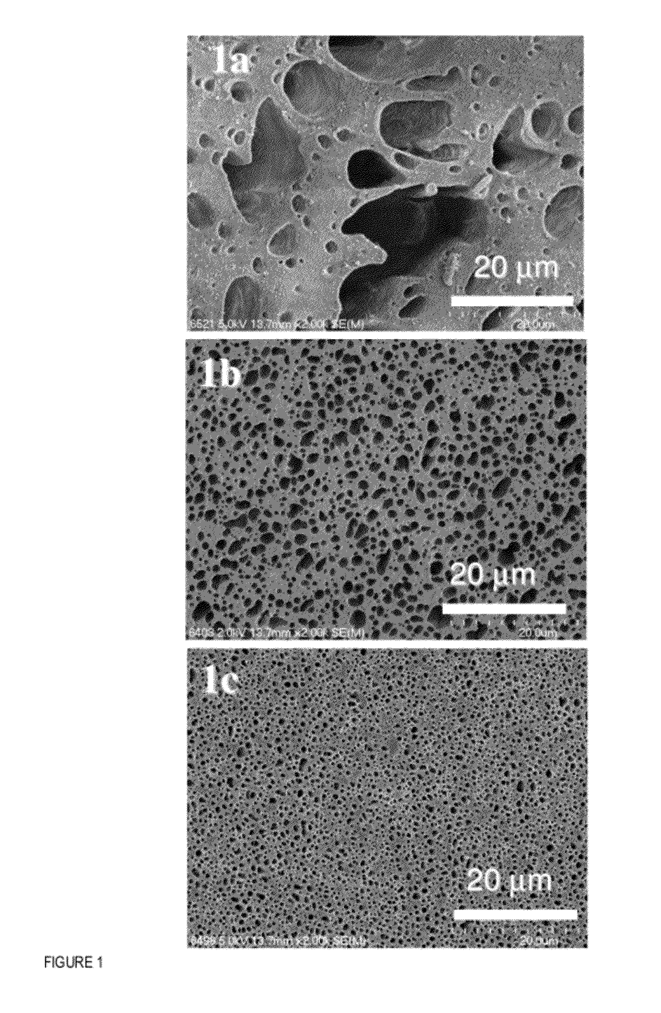

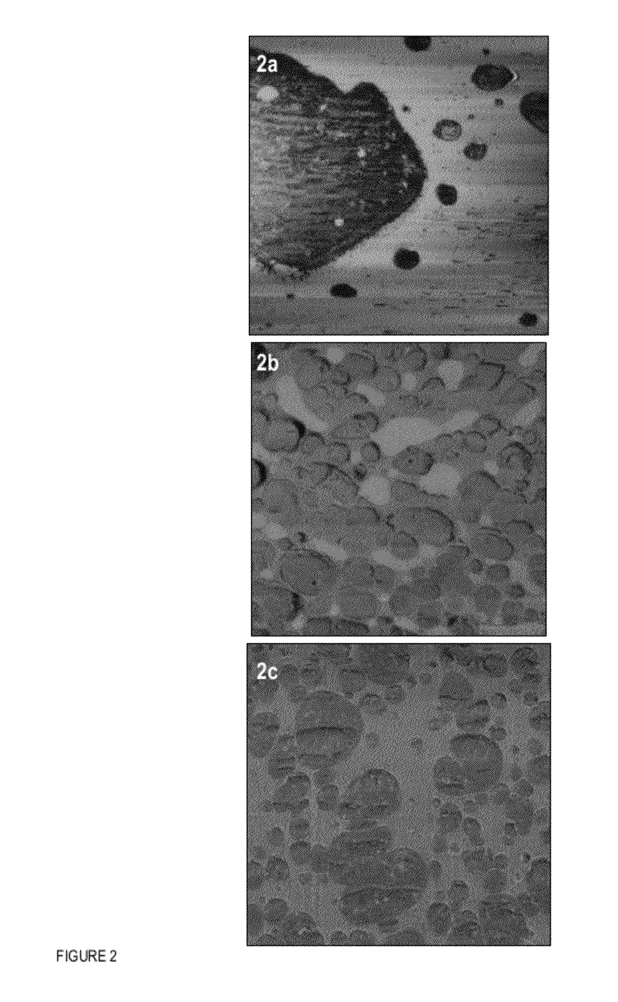

The cross section morphology differences between TPS/PLA and TPS/PBAT blends are shown in FIG. 1 and FIG. 2. FIG. 1 shows the SEM micrographs of the blend and FIG. 2, the AFM micrographs. FIG. (1a) shows the morphology of a TPS/PLA blend whereas FIG. 1c) shows the morphology of a TPS/PBAT blend. It appears that the TPS domains (extracted by HCl during 3 hours) are smaller and more homogenous when TPS is blended with PBAT rather than PLA. The affinity of the PBAT with the TPS is better than with PLA. The TPS/PLA/PBAT blend, FIG. (1b), shows an intermediate morphology: the TPS domains are bigger in size than in TPS/PBAT blend but the size is homogenous and much smaller than in TPS/PLA blend.

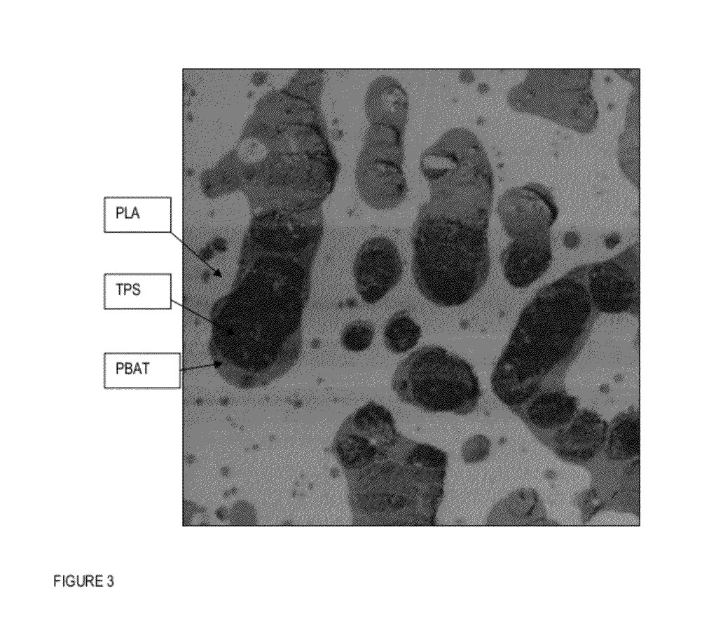

In FIG. (2b), the lighter phase is the PLA and it appears that the TPS domains are trapped inside the PBAT domains. This phenomenon is illustrated in more detail in FIG. 3 where the various phase are identified. The encapsulation of TPS domains by PBAT is clearly seen (dark grey TPS domains appear coated with lighter gray PBAT in pale grey PLA). No TPS domains were observed in the PLA phase where essentially full encapsulation was observed. It was observed that the TPS domains selectively drive into the PBAT.

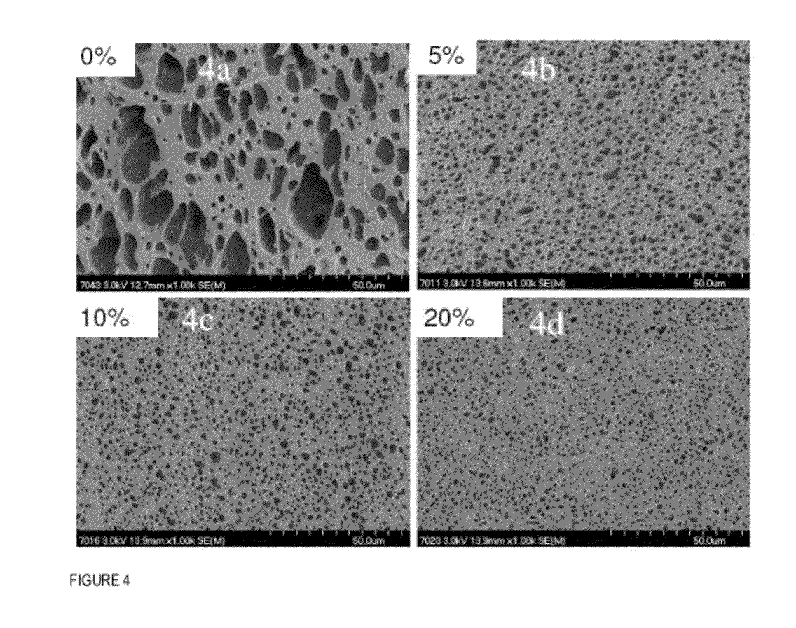

FIG. 1 shows that adding PBAT to a TPS/PLA blend has a significant effect on decreasing the TPS domain size. In FIG. 4, the TPS/PLA blend SEM pictures prepared with different amounts of PBAT are presented (TPS phase extracted). One can observe that with only 5 wt % of PBAT, the decrease and the homogeneity of the TPS domain size was already observed. The effect was even more pronounced for PBAT content higher than 5 wt %.

Tensile and Impact Properties

After extrusion, samples were injection molded into dumbbell-shape specimens and into rectangular bars with a Sumitomo SE50S injection machine. Samples were conditioned for 48 h at 23° C. and 50% humidity. Tensile measurements were performed according to ASTM D638 with an Instron™ 4400R universal testing machine at a crosshead speed of 50 mm/min. At least ten specimens of each sample were tested and their average value was reported with their standard deviation bars. Unnotched and notched specimen measurements were performed with the Resil 25 Izod impact tester from Ceast™ according to ASTM D-256 and ASTM D-4812. Seven to twelve specimens were tested and their average value was reported with their standard deviation bars.

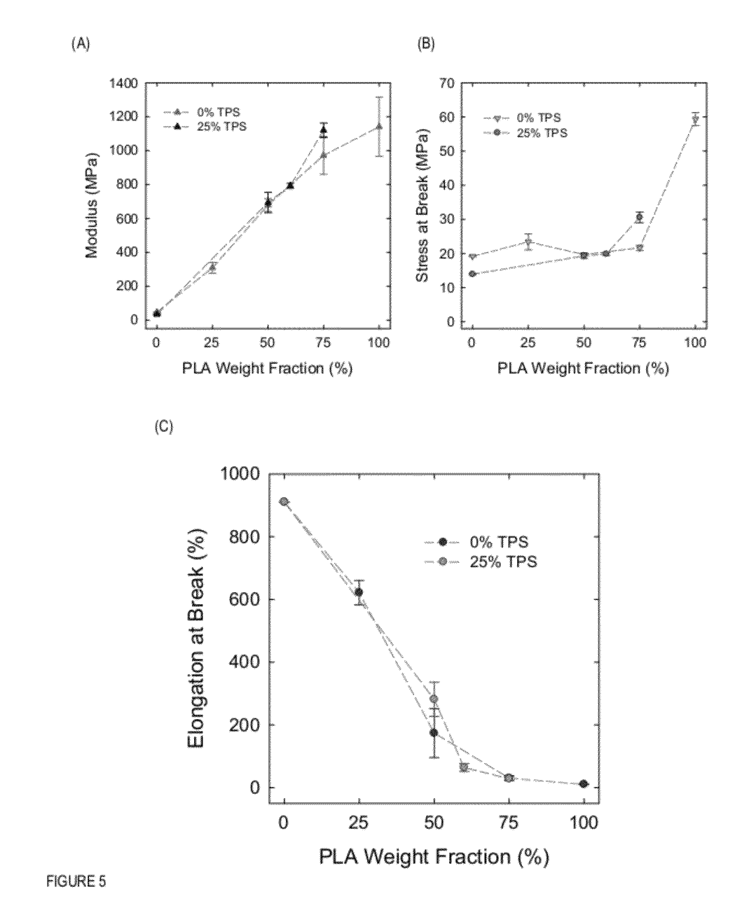

The tensile properties (Young Modulus, Stress at break and Elongation at break) of TPS/PLA/PBAT are shown in FIGS. 5 A, B and C, respectively. They are compared to PLA/PBAT blends. The results show an increase of the modulus and stress at break and a decrease of elongation at break with the amount of PLA, which is to be expected due to the rigid character of PLA. What is really interesting is that for both blends, the mechanical properties are similar. It is thus apparent that the addition of TPS into the PLA/PBAT blend has little detrimental effect on the mechanical properties of the final blend. At 50% wt PLA (25% wt PBAT and 25% wt TPS), the elongation at break even reaches 200%, which is a substantial improvement compared to pure PLA.

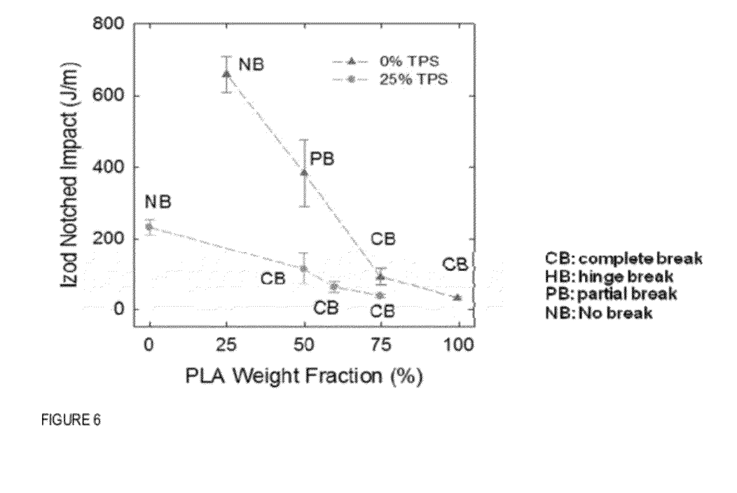

The impact properties of the notched specimen are shown in FIG. 6. As for tensile properties, a comparison is made between PLA/PBAT and TPS/PLA/PBAT blends. FIG. 6 shows better results for PLA/PBAT than a TPS/PLA/PBAT blend, but the properties are acceptable being twice to six times the impact energy of pure PLA for TPS/PLA/PBAT blend 25/50/25.

The ternary blend properties show a good retention of PLA/PBAT properties even with a high amount of TPS (25 wt %). The cost is reduced and the biobased and renewable content is increased since PBAT is not a biobased resin.

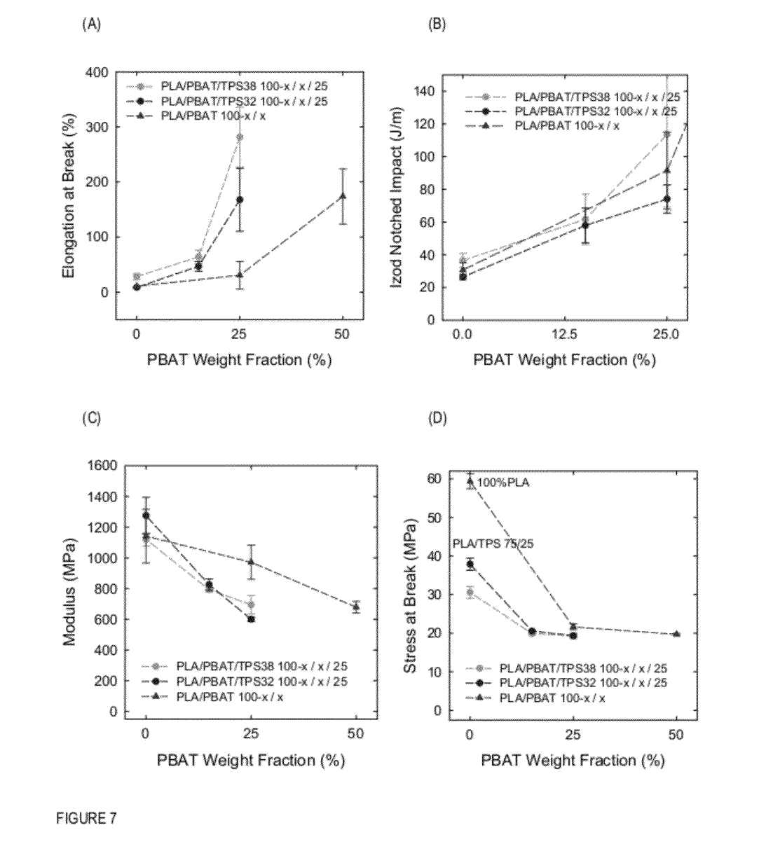

FIGS. 7 (A) to (D) show the tensile and impact properties of the blends as a function of PBAT content. It appears from these figures that for the same level of PBAT, TPS/PLA/PBAT blends can match the properties of PLA/PBAT or even surpass them by increasing the plasticizer fraction in TPS.

### Example 2

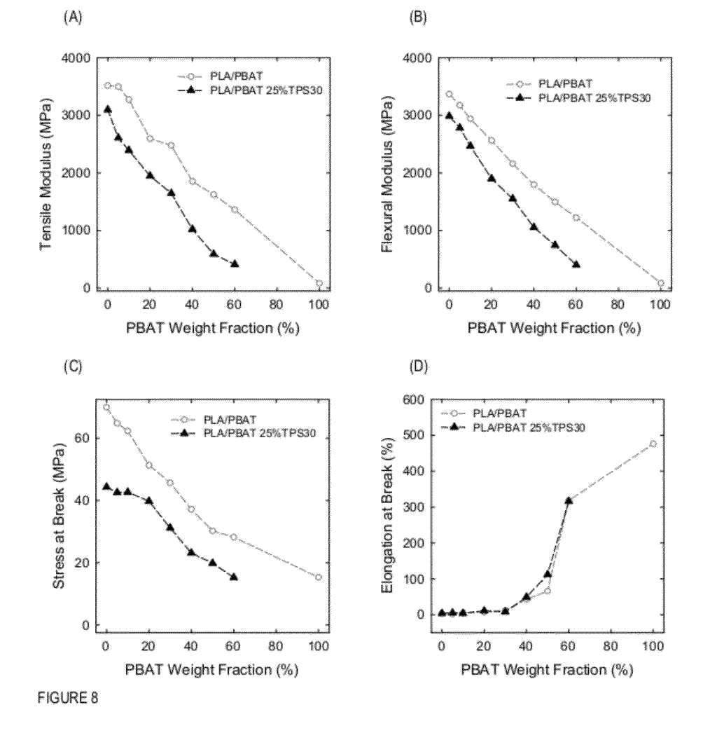

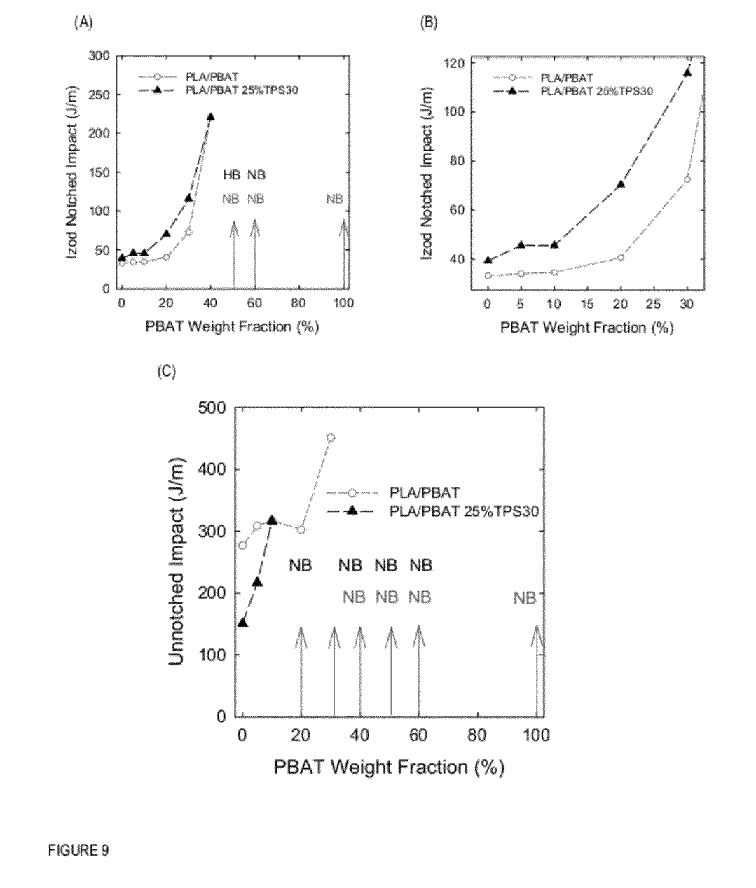

FIGS. 8 and 9 show further testing for the mechanical properties of PLA/PBAT blends vs. PLA/TPS/PBAT blends. For the PLA/PBAT blends, pellets of PLA and pellets of PBAT were blended in injection molding. For PLA/TPS/PBAT, pellets of PBAT/TPS or of PLA/PBAT/TPS were blended with PLA in injection molding. The TPS contained 70% wt potato starch and 30% wt glycerol.

In FIG. 8, it appears that the elongations at break of the PLA/PBAT and PLA/PBAT/TPS are very similar. In FIG. 9, the Notched impact is better for the ternary blends (top graphs). The Izod Notched impact graph in FIG. 9(B), which is an enlargement of FIG. 9(A), shows that the ternary blends demonstrated the highest Notched impact for 0 to 30% wt PBAT. There was no break for blends containing PBAT at more than 50 wt %. At 10% wt PBAT, the unnotched impact of the PLA/PBAT and PLA/PBAT/TPS are similar (FIG. 9(C)). For 20 and 30% wt PBAT, the unnotched impact is better for the ternary blends. For 40% wt PBAT and up, no break was observed for the unnotched impact for both types of blends.

### Example 3

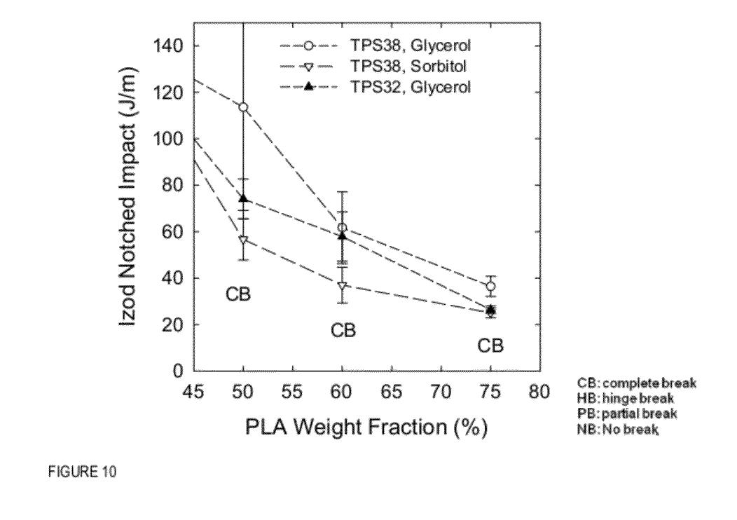

Tests were also carried out in order to compare different starch plasticizers and different amount of plasticizer. FIG. 10 shows impact results for a TPS/PLA/PBAT blend, the TPS being plasticized by glycerol or sorbitol and containing 32 or 38 wt % of plasticizer, based on the total weight of the thermoplastic starch. For 38 wt % of plasticizer, the results show an increase of the impact resistance with glycerol, compared to sorbitol. The increase is even more pronounced when the level of plasticizer is increased. It thus appears that with more plasticizer, the TPS is less rigid and exhibits more resistance to impact.

The results show that the type and the quantity of the plasticizer are parameters that may be used to control the mechanical properties of the final blend.

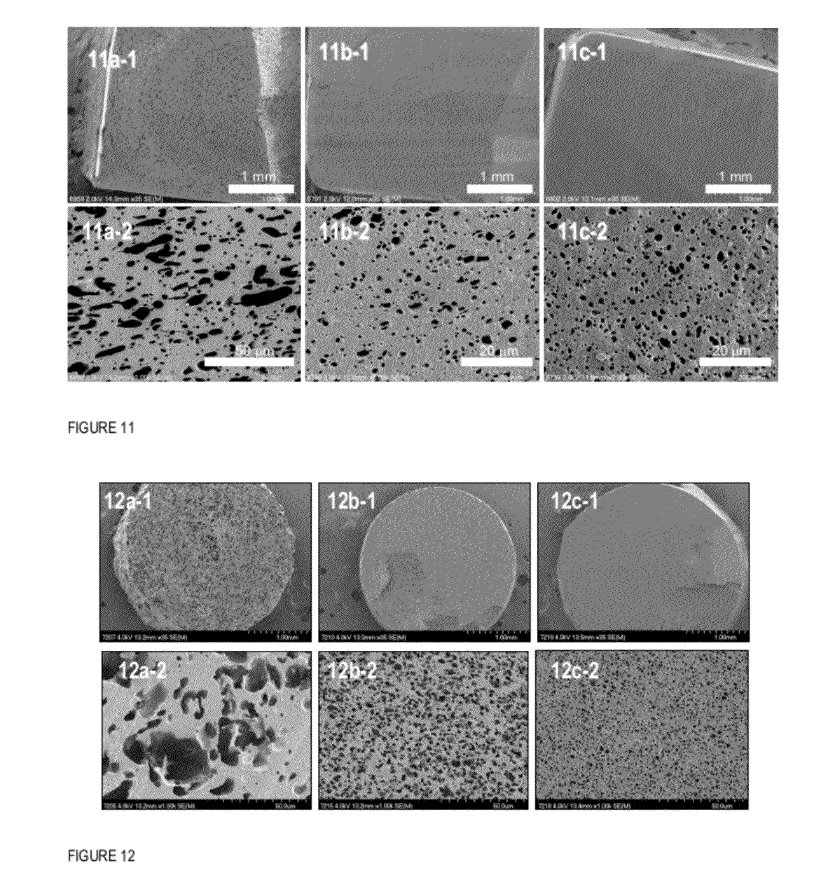

Microtomy was carried out on a cross-section of the tensile specimens. The microtomed surfaces were coated with a gold-palladium alloy and observed by SEM. The results for the TPS/PLA/PBAT blend are shown in FIG. 11. As observed above, the presence of PBAT in the blend significantly reduces the size of the TPS domains. The TPS/PLA blend without PBAT shows inhomogeneous and large sized domains of TPS. 15 wt % of PBAT only was enough to considerably decrease the size of the TPS domains in injection molded articles.

### Example 4

The above examples illustrated TPS/PLA/PBAT blends. However, as previously mentioned, other polymers can replace the PBAT and PLA to yield the encapsulation morphology. Examples of second polymers include:
PBSA (Polybutylene succinate adipate),
PBS (Polybutylene succinate),
PCL (Polycaprolactone),
PVOH (Poly vinyl alcohol), and
VAE (Vinyl Acetate Ethylene),
   and examples of first polymers include PHBV (Polyhydroxybutyrate valerate) and another PHA (Polyhydroxyalkanoate).

FIG. 12 shows SEM results for TPS/PHBV, TPS/PHBV/PVOH and TPS/PHBV/PBAT. TPS domains are quite large and inhomogeneous when TPS is blended with PHBV (FIG. 12a). This result is similar to that observed for the PLA blend in FIG. 1a. However, when 10 wt % of PVOH or PBAT are added into the blend (FIGS. 12b and 12c), the morphology is much better and shows an important decrease of the size of the TPS phases.

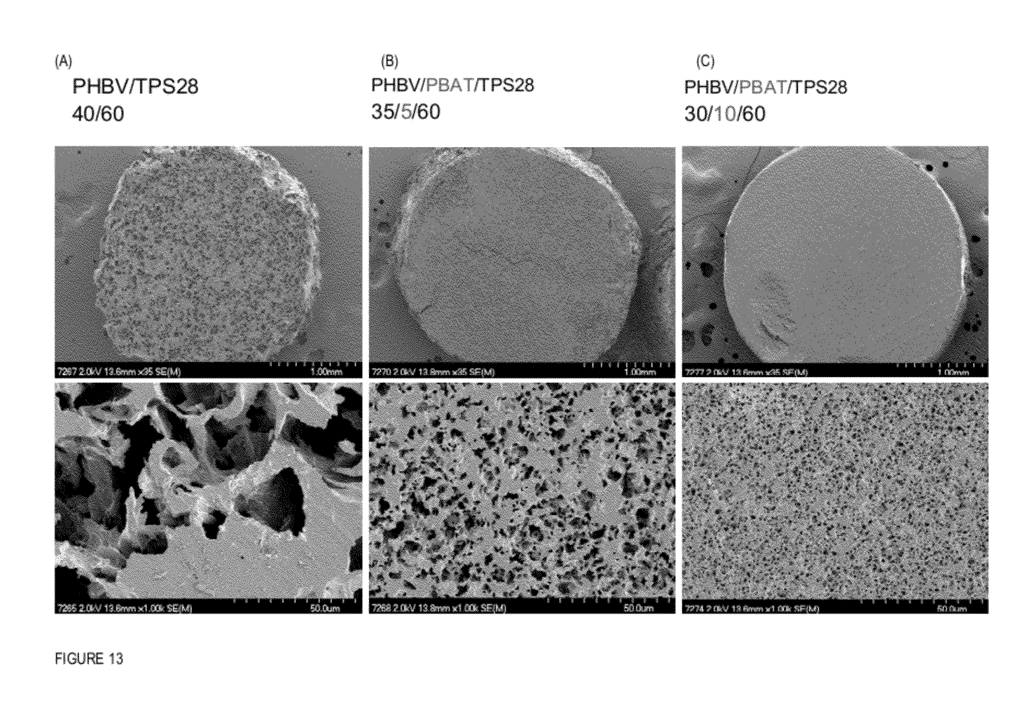

Similar results were obtained in FIGS. 13 (A), (B) and (C) where it appears that increasing the amount of PBAT in PHBV/TPS blends yields smaller and more homogenous TPS domains. This indicates encapsulation of TPS by PBAT in the PHBV blend.

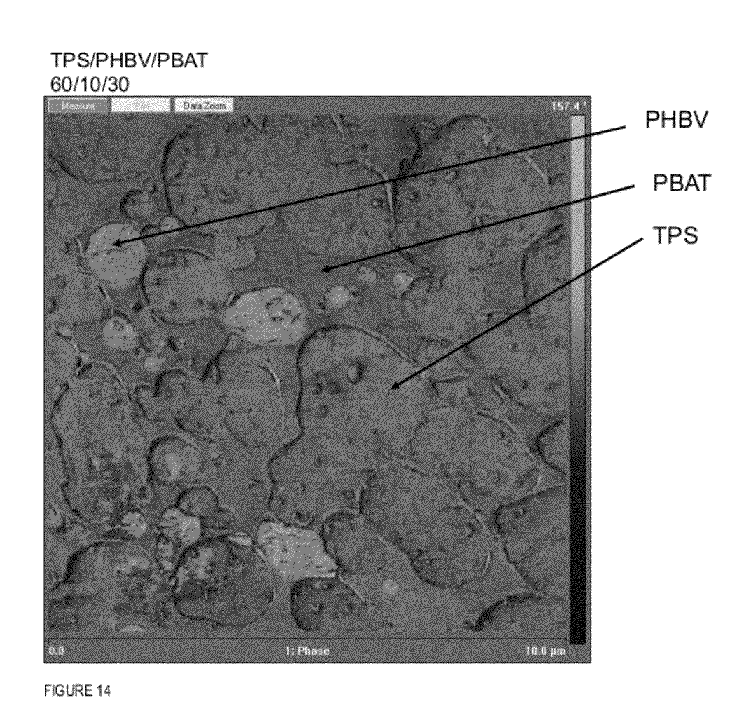

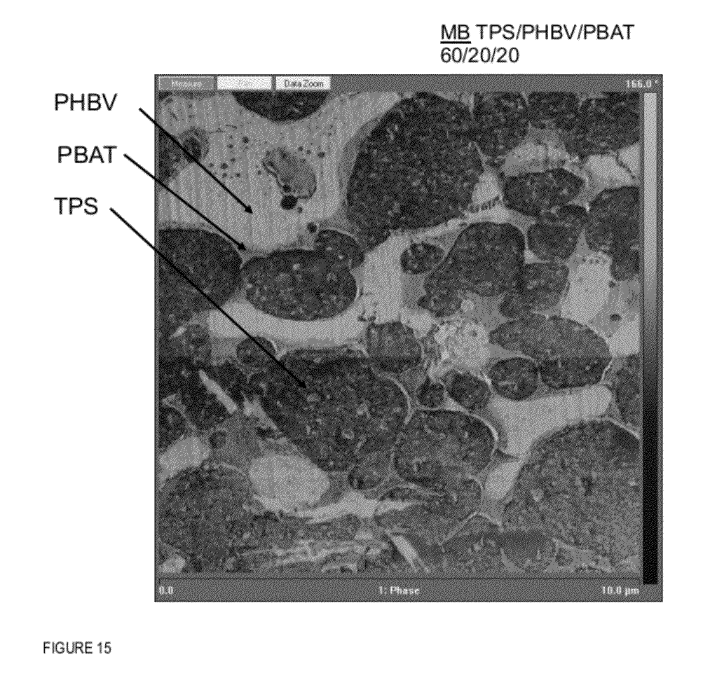

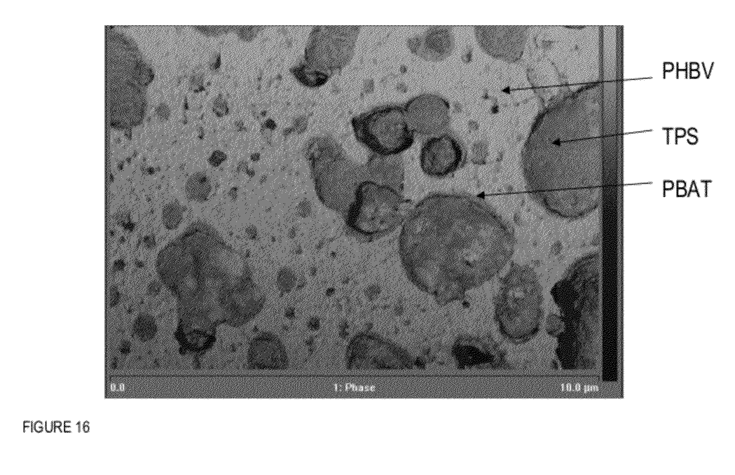

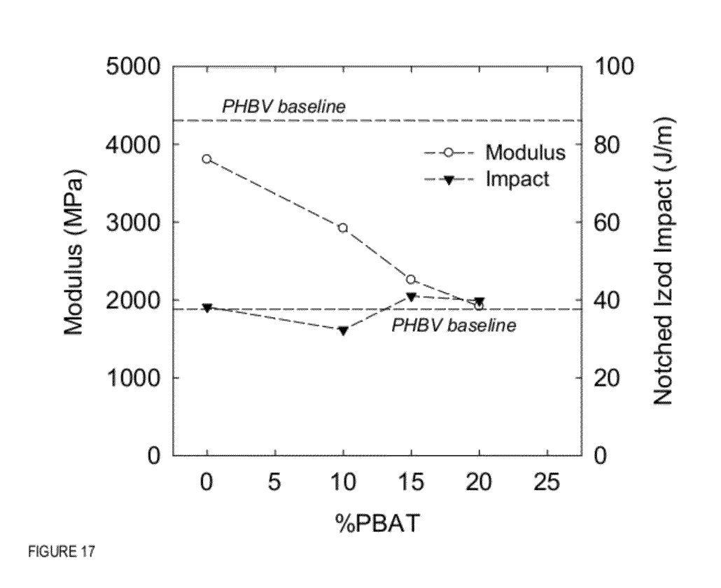

The morphologies of two TPS/PVBH/PBAT blends are shown in FIGS. 14 (TPS/PVBH/PBAT 60/10/30 blend) and 15 (TPS/PVBH/PBAT 60/20/20 blend). A blend obtained by diluting the TPS/PVBH/PBAT 60/10/30 blend using 50% of PVBH (i.e. a TPS/PVBH/PBAT 30/55/15 blend) was also studied. The morphology of this blend is shown in FIG. 16. The PVHB was the ENMAT™ Injection Molding Grade Y1000P from TianAn. In all cases, the TPS domains are encapsulated in the PBAT. It should be noted that the PBAT forms continuous phase in the 60/10/30 blend, while the PVBH forms the continuous phase in the 30/55/15 blend. The Young modulus and Notched Izod Impact of TPS/PVBH/PBAT blends containing 30 wt % TPS and various amounts of PBAT are shown in FIG. 17. A more flexible material is obtained, while the notched Izod impact resistance is maintained.

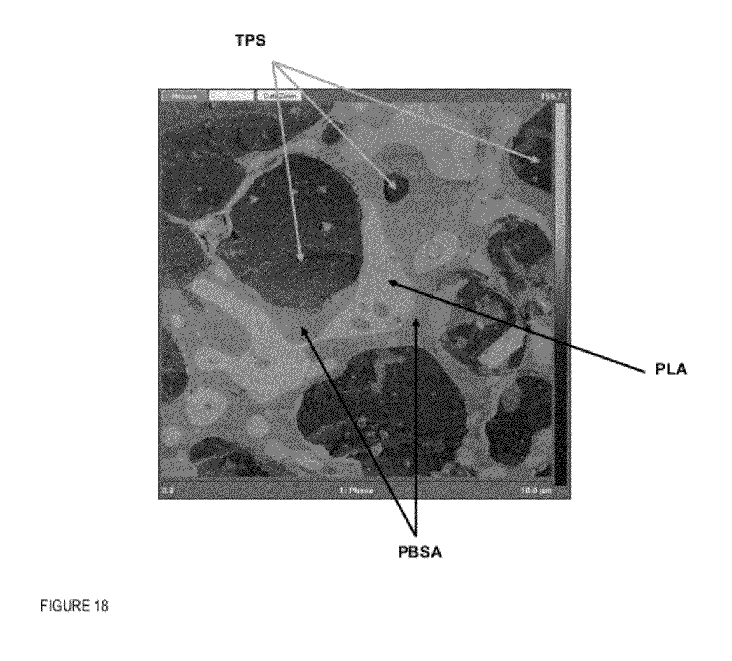

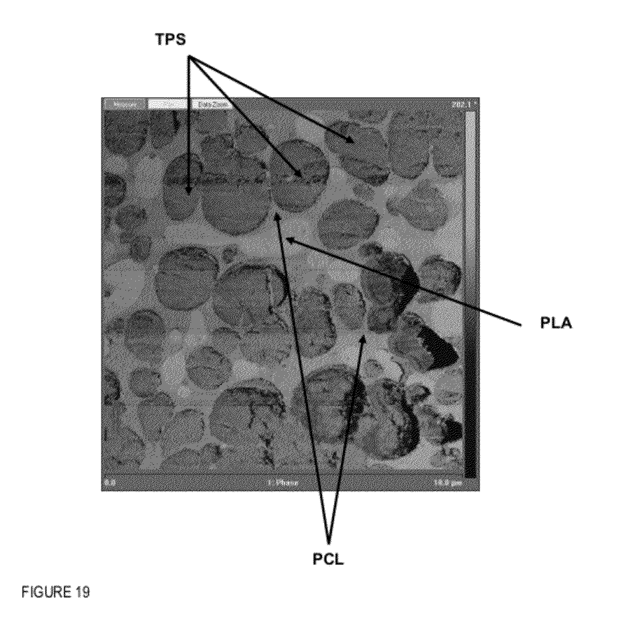

Morphologies of TPS/PLA/PBSA and TPS/PLA/PCL were also studied and are shown in FIGS. 18 and 19, respectively. It was found that the TPS is encapsulated in the PBSA and in the PCL.

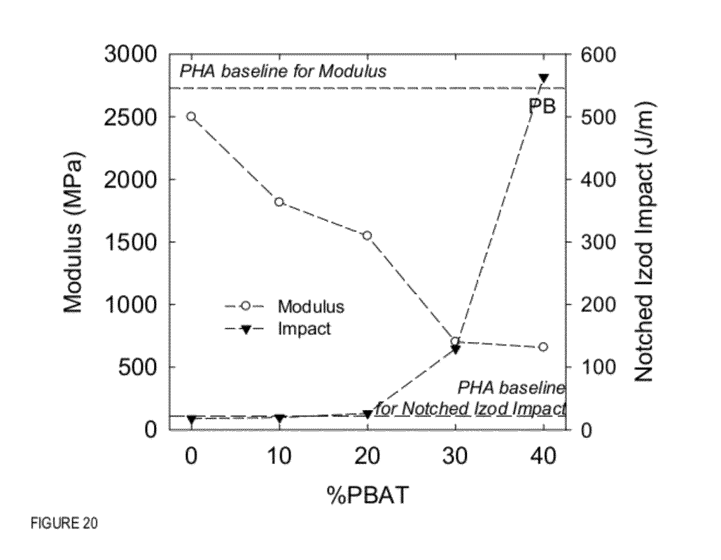

The Young modulus and Notched Izod Impact of TPS/PHA/PBAT blends containing 30% TPS and various amounts of PBAT are shown in FIG. 20. The PHA was the EM 20010 of Ecomann™ (CAS117068-64-1). Again, a more flexible material is obtained, while the notched Izod impact resistance is maintained. When PBAT is higher than 20 wt %, a very large improvement of the notched Izod impact can be observed.

### Example 5

Further industrial scale PLA ternary blends were made as per Table 1 and Table 2. In Table 1, samples 1, 2 and 3 are binary blends of PLA and TPS in which the second polymer PBAT was not added, had properties similar to those of PLA. The unnotched impact resistance of these samples was even less than that of pure PLA. However, when PBAT was added, all the measured properties were enhanced. It appears that the plasticizer amount and type also had an effect on the properties.

In samples 9-11 of the Table 1, the mineral charge talc was added in addition to the PBAT. The mechanical properties obtained for these samples were good when compared to pure PLA, in spite of the addition of 7.5-10 wt % talc.

In Table 2, it is shown that as low as 5 wt % PBAT allows enhancement of the properties when compared to pure PLA or PLA/TPS in Table 1. The properties of the blends containing 20, 30 and 40 wt % TPS are industrially acceptable.

TABLE 1

| | % Plasticizer | | | % | % | % | Elongation | Notched Izod | Unnotched | Gardner |
|---|---|---|---|---|---|---|---|---|---|---|
| | in TPS | Starch Type | Plasticizer Type | TPS | PBAT | Talc | at break (%) | Impact (J/m) CB | Impact (J/m) | impact (lbs) |
| Pure PLA 3001D | | | | | | | 5.2 | 23 | 208 | <8 |
| 1 | 28 | Corn | Glycerol | 25 | 0 | 0 | 5.4 | 23 | 103 | <8 |
| 2 | 38 | Corn | Sorbitol | 25 | 0 | 0 | 5.9 | 24 | 102 | <8 |
| 3 | 33 | Corn | Glycerol:Sorbitol 1:1 | 25 | 0 | 10 | 4.7 | 23 | 98 | <8 |
| 4 | 29 | Corn | Glycerol:Sorbitol 2.6:1 | 25 | 7 | 0 | 4.0 | 47 | 731 | 48 |
| 5 | 29 | Corn | Glycerol:Sorbitol 1:2.8 | 25 | 19 | 0 | 14 | 57 | NB (1042) | 56 |
| 6 | 32 | Corn | Glycerol:Sorbitol 2.2:1 | 25 | 20 | 0 | 29 | 61 | NB (1848) | 248 |
| 7 | 38 | Corn | Glycerol | 25 | 25 | 0 | 191 | 80 | NB (1761) | >320 (NB) |
| 8 | 28 | Corn | Sorbitol | 25 | 25 | 0 | 22 | 57 | NB (933) | 224 |
| 9 | 30 | Potato | Glycerol:Sorbitol 1:1 | 25 | 22.5 | 7.5 | 24 | 92 | NB (1433) | >320 (NB) |
| 10 | 33 | Corn | Glycerol:Sorbitol 1:1 | 25 | 25 | 10 | 13 | 45 | 661 | 64 |
| 11 | 38 | Corn | Glycerol | 25 | 35 | 10 | 139 | 139 | NB (1471) | 304 |

TABLE 2

| | % Plasticizer | Starch | Plasticizer | % | % | Notched Izod | Unnotched |
|---|---|---|---|---|---|---|---|
| | in TPS | Type | Type | TPS | PBAT | Impact (J/m) CB | Impact (J/m) |
| Pure PLA 3001D | | | | | | 23 | 208 |
| 12 | 26 | Potato | Glycerol | 20 | 5 | 43 | 310 |
| 13 | 26 | Potato | Glycerol | 40 | 5 | 37 | 452 |
| 14 | 30 | Potato | Glycerol | 40 | 5 | 50 | 717 |
| 15 | 28 | Potato | Glycerol | 30 | 25 | 89 | NB (1275) |

### Example 6

Table 3 shows the effect of PBSA in PLA/TPS blends. The TPS was present at 25 wt %. This table indicates that as low as 2.5 or 5 wt % PBSA allows the improvement of the impact properties when compared to pure PLA or PLA/TPS blend.

TABLE 3

| | % | | | | | Elongation | Notched | Unnotched |
|---|---|---|---|---|---|---|---|---|
| | Plasticizer | Starch | Plasticizer | % | % | at break | Izod Impact | Izod Impact |
| | in TPS | Type | Type | TPS | PBSA | (%) | (J/m) | (J/m) |
| Pure PLA 3001D | | | | | | 8.2 | 20 | 195 |
| 16 | 38 | Corn | Glycerol | 25 | 0 | 11 | 23 | 173 |
| 17 | 38 | Corn | Glycerol | 25 | 2.5 | 29 | 31 | 641 |
| 18 | 38 | Corn | Glycerol | 25 | 5 | 33 | 31 | 724 |
| 19 | 38 | Corn | Glycerol | 25 | 15 | 44 | — | — |
| 20 | 38 | Corn | Glycerol | 25 | 25 | 57 | 34 | 914 |

The scope of the claims should not be limited by the preferred embodiments set forth in the examples above, but should be given the broadest interpretation consistent with the description as a whole.

### REFERENCES

The present description refers to a number of documents, the content of which is herein incorporated by reference in their entirety.
Vink E. T. H., Rabago K. R., Glassner D. A. Gruber P. R. (2003) Polymer Degradation and Stability, 80, 403-419
Parker R., Ring S. G. (2005) The physical chemistry of starch, chapter 24, p. 591-604. In Dumitriu Severian, editor. Polysaccharides, structural diversity and functional versatility, 2nd ed. New York: Marcel Dekker Inc.
Martin O., Avérous L. (2001) Polymer, 42, 6209-6219.
Park J. W., Im S. S., Kim S. H., Kim Y. H. (2000) Polymer Engineering and Science, 40, 2539-2550.
Sailaja R. R. N., Chanda M. (2000) Journal of Polymer Materials, 17, 165-76.
Sarazin P., Gang L., Orts W. J., Favis B. D. (2008) Polymer, 49, 599-609
Liao H., Wu C. (2009) Materials Science and Engineering, A 515, 207-214
Ren J., Fu H., Ren T., Yuan W. (2009) Carbohydrate Polymers, 77, 576-582
Lawrence S, ST, Walia P. S., Willett J. L. (2003) Polymer Engineering and Science, 43, 1250-1260
Lawrence S. ST, Walia P. S., Felker F., Willett J. L. (2004) Polymer Engineering and Science, 44, 839-1847
Shogren R. L., Doane W. M., Garlotta D., Lawton J. W., Willett, J. L. (2003) Polymer Degradation and Stability, 79, 405-411
Tachibana Y., Maeda T., Ito O., Maeda Y., Kunioka M. (2009) International Journal of Molecular Sciences, 10, 3599-3615
Parulekar Y., Mohanty A. K. (2007) Macromolecular Materials and Engineering, 292, 1218-1228
Wang et al. US 2009/0324917 A1; Tomka, U.S. Pat. No. 5,844,023;
McCarthy et al., U.S. Pat. No. 5,883,199; Tomka, U.S. Pat. No. 6,117,925;
Warzelhan et al., U.S. Pat. No. 6,303,677; U.S. Pat. No. 6,844,380;
Bastioli et al., U.S. Pat. No. 6,841,597; U.S. Pat. No. 6,605,657;
Bastioli et al., US 2005/0054813; U.S. Pat. No. 6,844,380; and
Bastioli et al., US 2008/0188593 A1; US patent application publication No.
Berger et al. U.S. Pat. No. 6,933,335; 2008/0287592 A1.

1. A polymer blend comprising a first polymer and a second polymer, and further comprising thermoplastic starch being at least partially encapsulated in said second polymer.

2. The polymer blend of claim 1, wherein the thermoplastic starch is totally encapsulated in said second polymer.

3. The polymer blend of claim 1, wherein said second polymer is a polyester such as poly(butylene adipate co-terephtalate) (PBAT), polybutylene succinate (PBS), polybutylene succinate-co-adipate (PBSA), or polycaprolactone (PCL), polyvinyl alcohol (PVOH), ethylene vinyl alcohol (EVOH), polyamide (PA), polyether block amide (PEBA), polystyrene, a polyolefin, ethylene vinyl acetate (EVA), or mixtures thereof.

4. The polymer blend of claim 3, wherein said second polymer is poly(butylene adipate co-terephtalate) (PBAT), polyvinyl alcohol (PVOH), polybutylene succinate-co-adipate (PBSA), or polycaprolactone (PCL).

5. The polymer blend of claim 1, wherein said first polymer is a poly(hydroxyalkanoate) (PHA), a copolymer of poly(hydroxyalkanoates), poly(3-hydroxybutyrate-hydroxyvalerate) (PHBV), a polyester such as an aliphatic polyester, a thermoplastic homopolymer resin, a vinyl polymer, a polystyrene, a substantially water-insoluble polyacrylate or polymethacrylate, a polyacetal, a polyamide, a polyarylether, a polyurethane, a polycarbonate, a polyimide, a high molar mass substantially water-insoluble or crystallizable poly(alkylene oxide), a water-insoluble thermoplastic alpha-olefin copolymer, an acrylic acid ester/acrylonitrile copolymer, acrylamide/acrylonitrile copolymer, a block copolymer of amide-ester, a block copolymer of urethane-ether, block copolymers of urethane-ester, a polyolefin, alkylene/vinyl ester-copolymers or mixtures thereof.

6. The polymer blend of claim 1, wherein said first polymer is poly(lactic acid) (PLA), poly(glycolic acid), polybutylene succinate, copolymers comprising the repetitive units of poly(glycolic acid) and polybutylene succinate, polyethylene (PE), polypropylene (PP), polyisobutylene, poly (vinyl chloride) (PVC), poly (vinyl acetate) (PVA), poly (acrylic acid) esters, poly (methacrylic acid) esters, nylon6, nylon-6,6, an aliphatic or aromatic polyamide, poly(ethylene terephthalate) (PET), poly(butylene terephthalate) (PBT), poly(ethylene oxide), poly(propylene oxide), ethylene/vinyl acetate-copolymers (EVA), ethylene/vinyl alcohol-copolymers (EVAL); alkylene/acrylate or methacrylate-copolymers, ethylene/acrylic acid-copolymers (EAA), ethylene/ethyl acrylate-copolymers (EEA), ethylene/methyl acrylate-copolymers (EMA); alkylene/maleic anhydride-copolymers, ethylene/maleic anhydride-copolymers, random, block, graft or core-shell styrenic copolymers, alpha-olefin/styrene-copolymers, hydrogenated and non-hydrogenated styrene/ethylene-butylene/styrene copolymers (SEBS), styrene/ethylene-butadiene copolymers (SEB); styrene acrylonitrile copolymers (SAN), acrylonitrile/butadiene/styrene copolymers (ABS), or mixtures thereof.

7. The polymer blend of claim 1, wherein the first and second polymers are:

| First polymer | Second polymer |
|---|---|
| PHA | PBAT |
| PLA | PBAT |
| PHBV | PVOH |
| PHBV | PBAT |
| PLA | PBSA |
| PLA | PCL. |

8. The polymer blend of claim 1, wherein said second polymer is PBAT.

9. The polymer blend of claim 1, wherein said second polymer is PBSA.

10. The polymer blend of claim 1, wherein said second polymer is PCL.

11. The polymer blend of claim 1, wherein said second polymer is PVOH.

12. The polymer blend of claim 1, wherein said first polymer is polylactic acid.

13. The polymer blend of claim 1, wherein said first polymer is poly(3-hydroxybutyrate-hydroxyvalerate) (PHBV).

14. The polymer blend of claim 1, wherein said blend exhibits an elongation at break measured according to ASTM D-638 of at least 20%, 50, 100%, or 200%.

15. The polymer blend of claim 1, wherein said blend exhibits an Izod notched impact resistance measured according to ASTM D-256 of at least 40, 60 or 80 J/m.

16. The polymer blend of claim 1, wherein said blend comprises from about 1 wt % up to about 79 wt % of thermoplastic starch, based on the total weight of the blend.

17. The polymer blend of claim 1, wherein said blend comprises up to about 50 wt % of said second polymer, based on the total weight of the blend.

18. The polymer blend of claim 1, wherein said blend comprises at least about 10 wt % of said second polymer, based on the total weight of the blend.

19. The polymer blend of claim 1, wherein said blend comprises from 20 wt % up to about 98 wt % of the first polymer, based on the total weight of the blend.

20. The polymer blend of claim 1, wherein said thermoplastic starch comprises a plasticizer which is glycerol, sorbitol, a polyol or a mixture thereof.
